(19) United States
(12) Patent Application Publication
(10) Pub. No.: US 2007/0202430 A1
(43) Pub. Date: Aug. 30, 2007

(54) CARRIER AND DEVELOPER FOR FORMING LATENT ELECTROSTATIC IMAGES, ASSOCIATED APPARATUS AND METHODOLOGY

(76) Inventors: Kousuke Suzuki, Numazu-shi (JP); Tomio Kondou, Numazu-shi (JP); Masahide Yamashita, Ohta-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/744,014

(22) Filed: May 3, 2007

Related U.S. Application Data
(62) Division of application No. 10/961,071, filed on Oct. 12, 2004.

(30) Foreign Application Priority Data
Oct. 10, 2003 (JP) 2003-352786

(51) Int. Cl. G03G 9/113

(52) U.S. Cl. 430/111.35; 430/122.2

(57) ABSTRACT

A carrier for a double component developer for developing latent electrostatic images at least contains a particulate core material having a weight average particle diameter (Dw) of from 25 to 45 μm and a magnetic moment of from 65 to 90 Am²/Kg at 1 KOe and a resin layer located on the surface of the particulate core material. Further, the carrier has a breakdown voltage not less than 1,000 V.

### CROSS-REFERENCE TO RELATED APPLICATIONS

This application is a Divisional of and claims the benefit of priority under 35 U.S.C. § 120 from U.S. Ser. No. 10/961,071, filed Oct. 12, 2004, and claims the benefit of priority under 35 U.S.C. § 119 from Japanese Patent Application priority document, 2003-352786 filed in Japan on Oct. 10, 2003, the entire contents of each of which are incorporated herein by reference.

### BACKGROUND OF THE INVENTION

1. Field of the Invention

The present invention relates to a carrier for use in a developer configured to develop latent electrostatic images and a developer containing the carrier, and more particularly relates to a developer container, an image forming apparatus such as copiers and laser beam printers, a developing method and a process cartridge.

2. Discussion of the Background

Electrophotographic developing systems are typically classified into two main developing systems. One is a single-component developing system and the other is a double-component developing system. The single-component system uses only a toner as a main component. In the double-component developing system, a toner is mixed for use with a non-coated carrier, such as a glass bead carrier and a magnetic carrier, or with a coated carrier the surface of which is coated by, for example, a resin.

The carrier used for the double-component developing system has a wide friction charge area for toner particles. Therefore the toner used together with the carrier in the double-component system has relatively stable charging properties relative to those of the toner used for the single-component developing system. This provides an advantage of maintaining image quality for a long period of time. In addition, since the double-component developing system is suitable for supplying toner to the developing area, the double-component developing system is especially adopted in high speed electrophotographic apparatuses.

Further, in a digital electrophotographic system in which a latent electrostatic image is formed on an image bearing member, such as a photoconductor, by a laser beam, etc. and then the latent electrostatic image is developed with a developer to be visualized, the double-component developing system having such advantages as mentioned above is widely adopted.

Recently, to satisfy the demand for images with higher definition and better highlight reproducibility, and for high quality color images, the minimum unit (i.e., pixel) of a latent image has been reduced in size and increased in density. Especially, a developing system capable of truly producing such a latent image (i.e., dots) has been expected to be introduced.

Various kinds of techniques concerning process conditions and developers (i.e., toners and carriers) have been proposed to obtain such a developing system. In light of the processes, it is effective to form a short gap in the development area, and to use a thin filming photoconductor and a writing beam having a small beam spot diameter. However, the techniques have drawbacks in that cost increase and reliability have not been solved.

When a toner having a small diameter is used as a developer, dot reproducibility can be greatly improved. However, a developer containing a toner having a small diameter poses problems such as the occurrence of background fouling and deficiency in image density.

In addition, in the case of full color developers including toners having a small diameter, a resin having a low softening temperature is used to obtain sufficient color tones. Thereby the amount of carrier spent increases compared with the case of a developer including a black toner. Thus the color developers easily deteriorate, resulting in occurrence of toner scattering and background fouling.

To use a carrier having a small diameter provides the following advantages.

(1) The surface area of the carrier particles per unit weight is so large that friction charge is sufficiently imparted to each toner particle. As a result, it is rare that toner particles are insufficiently or reversely charged. Consequently background fouling rarely occurs. In addition, the resultant dot images hardly scatter and blur, i.e., dot reproducibility can be improved.

(2) Since the surface area of the carrier particles per unit weight is large, the toner has sharp charge amount distribution. Therefore, the average amount of charge of the toner can be decreased. Even in this case, the resultant toner images have a proper image density and the background fouling problem rarely occurs because the toner images includes few weakly charged toner particles. This means that a carrier having a small diameter can compensate disadvantages when a toner having a small diameter is used. Namely, a carrier having a small diameter is especially effective in extracting advantages of a toner having a small particle diameter.

(3) A carrier having a small diameter forms a dense magnetic brush including filaments having a good mobility and thereby the trace of the filaments is hardly formed on an image.

However, a carrier having a small particle diameter has a serious problem in that carrier particles adhere to latent electrostatic images on an image bearing member or scatter in image forming apparatus. Further, such carrier particles damage the image bearing member (also referred to as a latent electrostatic image bearing member or photoconductor) and a fixing roller and therefore are not suitable for practical use.

As a solution to this issue, published unexamined Japanese Patent Application No. (JP-A) 2002-296846 (“'846 application”) discloses a carrier for electrophotography having a particulate core material having a volume average particle diameter of from 25 to 45 μm and an average space diameter of from 10 to 20 μm. Further, the ratio of the particulate core material having a diameter not greater than 22 μm is less than 1%. Furthermore, the particulate core material has a magnetization of from 67 to 88 emu/g at a magnetic field of 1 KOe and the difference of the magnetization between the core materials and scattered material is not greater than 10 emu/g.

The inventors of the present invention have confirmed that this carrier for electrophotography substantially improves the carrier adhesion and prevents occurrence of abnormal images such as mottled images caused by non-uniform density when digital images having a low definition, for example, 400 dpi, are produced. However, it has been also confirmed that abnormal images such as mottled images caused by non-uniform density are frequently produced when an analogue half tone image having image qualities simulated to a digital image with definition not less than 1,200 dpi is tried to be produced by a digital machine using a developing method in which an AC voltage overlapping with a DC voltage is used as the developing bias voltage.

That is, judging from the explanation in the '846 application that a halftone image is uniformly produced when a carrier having a small particle diameter is used, the '846 application seems to be based on the view that an abnormal halftone image is caused depending on the particle diameter of the carrier. The machine used for this evaluation was a 400 dpi full color photocopier (CF-70 manufactured by Konica Minolta Holdings, Inc.). Although the carrier particles described in the application can prevent occurrence of an abnormal halftone image produced at 400 dpi, it is considered that the carrier does not prevent occurrence of the abnormal halftone image problem caused by an electrical factor when digital images having resolution not less than 1200 dpi are produced by the developing method in which an AC voltage overlapping with a DC voltage is used as the developing bias voltage. The electrical factor is as follows: When the AC voltage is high, the appliedvoltage is also high. In this case, the filaments formed by the developer particles tend to electrically break down when the developer particles have a low resistance and thus a discharge easily occurs between the filaments and the image bearing member. This discharge affects images, resulting in abnormal images such as mottled images caused by non-uniform density especially in half tone image portions.

Generally as the image definition of a digital image increases, the digital image becomes more true to an input image. Therefore in electrophotography techniques for obtaining images having a resolution not less than 1200 dpi, which is higher than that of conventional images (400 dpi) have been studied and it was found that the resultant images have good highlight reproducibility and half tone reproducibility. However, quality images are not obtained by simply increasing the resolution and each dot of images is also required to be uniform. Good dot uniformity means that the amount of toner attached to each dot varies little.

In the case of an image with a high definition, the amount of toner attached to one dot decreases relative to that in the case of an image with a low definition because the diameter of one dot is small.

In this case, an entirely uniform image can be obtained as desired if the amount of toner attached to each dot can be controlled to be uniform. However, when the uniformity of the amounts of toner attached to the dots forming the image is poor, the image has an uneven image density. In the low definition image case, it is hard to recognize non-uniformity of the image even when the uniformity of the amount of toner attached to the dots forming the image is poor. This is because the absolute amount of toner attached to each dot is large.

Therefore, techniques for improving the dot uniformity of each dot have been recently studied to produce quality images with a high image definition.

The above-mentioned mottled image caused by non-uniform density at the constituent dots means a grained image with non-uniform density in a mottled manner in highlight to intermediate tone images. This abnormal image is considered to be formed because the dot uniformity mentioned above is poor.

The mottled non-uniform density image tends to appear when the image definition is high. The analogue halftone image mentioned above is equivalent to an output image having the highest resolution. Therefore, if the non-uniform density can be improved for this analogue halftone image, it is expected to actually produce a desired quality image with a high resolution.

The above-mentioned full color photocopier, CF-70 manufactured by Konica Minolta Holdings, Inc., has a relatively low definition of 400 dpi (dot diameter is about 60 μm) and therefore does not produce mottled images caused by non-uniform density.

That is, the abnormal halftone image discussed in the '846 application is not the mottled non-uniform density image discussed in the present application; the abnormal image is caused by coarse toner particles when the toner image is produced with an apparatus having a low image definition. Therefore, there is no disclosure in the '846 application regarding the abnormal halftone image caused by the developing method in which an AC voltage overlapping with a DC voltage is used as the developing bias voltage. Therefore the mottled image problem is a new problem to be solved.

Because of these reasons, a need exists for an image forming apparatus which can produce a quality image with a high definition even when the developing method in which an AC voltage overlapping with a DC voltage is used as the developing bias voltage.

### SUMMARY OF THE INVENTION

Accordingly, an object of the present invention is to provide a carrier having a small particle diameter for use in a developer developing latent electrostatic images which does not cause the carrier adhesion problem with a wide margin and produces good half tone images with uniform density while maintaining the advantages of the carrier being small.

Another object of the present invention is to provide a developer which can produce quality half tone images with uniform density.

Yet another object of the present invention is to provide a developer container containing the developer.

Still another object of the present invention is to provide an image forming apparatus using the developer, a developing method using the developer and a process cartridge containing the developer to produce quality images.

Briefly these objects and other objects of the present invention as hereinafter will become more readily apparent can be attained by a carrier for a double component developer for developing latent electrostatic images at least including a particulate core material having a weight average particle diameter (Dw) of from 25 to 45 μm and a magnetic moment of from 65 to 90 Am²/Kg at 1 KOe. In addition, a resin layer is located on the surface of the particulate core material and the carrier has a breakdown voltage not less than 1,000 V.

It is preferred that the particulate core material includes particulates having a diameter smaller than 22 μm in an amount not greater than 3% by weight.

It is still further preferred that the particulate core material includes particulates having a diameter smaller than 22 μm in an amount not greater than 1% by weight.

It is still further preferred that the particulate core material comprises a ferrite comprising Mn.

It is still further preferred that the resin layer comprises acrylic resins and/or silicone resins.

As another aspect of the present invention, a developer for use in developing latent electrostatic images is provided which comprises a toner, and the carrier mentioned above.

It is preferred that, in the developer for use in developing latent electrostatic images mentioned above, the toner has a weight average particle diameter (Dt) of from 3 to 10 μm.

As another aspect of the present invention, a developer container containing at least the developer mentioned above is provided.

As another aspect of the present invention, an image forming apparatus is provided which comprises an image bearing member configured to bear at least one latent electrostatic image thereon, at least one developing device comprising a developer holding member and configured to develop the latent electrostatic image with at least one developer which is the developer mentioned above to form at least one toner image on the image bearing member, a transfer device configured to transfer the at least one toner image onto a transfer medium and a fixing device configured to fix the at least one toner image on the transfer medium.

It is preferred that the image bearing member mentioned above includes a plurality of developing devices and bears a plurality of respective latent electrostatic images. The plurality of developing devices develop the plurality of respective latent electrostatic images with the respective developers including different color toners to form a plurality of color toner images on the image bearing member. In addition, the transfer device transfers the plurality of toner images onto the transfer medium to form a multi-color toner image and the fixing device fixes the multi-color image on the transfer medium.

It is still further preferred that, in the image forming apparatus mentioned above, a gap between the image bearing member and the developer holding member is 0.30 to 0.80 mm.

It is still further preferred that, in the image forming apparatus mentioned above, the developing device further comprises a voltage applying mechanism which applies a DC bias voltage to the developer holding member.

It is still further preferred that, in the image forming apparatus mentioned above, the developing device further comprises a voltage applying mechanism applying to the developer holding member a bias voltage in which an AC voltage overlaps with a DC voltage.

It is still further preferred that, in the image forming apparatus mentioned above, the image bearing member comprises an amorphous silicon photoconductor.

It is still further preferred that, in the image forming apparatus mentioned above, the fixing device comprises a heating member comprising a heat generator, a film which is rotated while contacting the heating member and a pressing member which pressure contacts the heating member under pressure with the film therebetween. The heating member and the film heat the at least one toner image while the pressure member presses the transfer medium to the film to fix at least one toner image on the transfer medium upon application of the heat while the transfer medium passes between the film and the pressing member.

It is still further preferred that the image forming apparatus mentioned above comprises the developer container mentioned above.

As another aspect of the present invention, there is provided a developing method comprising the steps of forming a latent electrostatic image on an image bearing member and developing the latent image with the developer mentioned above to form a toner image on the image bearing member.

As another aspect of the present invention, a process cartridge is provided which comprises a developing device configured to develop a latent electrostatic image with the developer mentioned above to form a toner image and at least one of an image bearing member configured to bear the latent electrostatic image thereon, a charger configured to charge the image bearing member and a cleaner configured to clean the surface of the image bearing member. The process cartridge is detachably attachable to an image forming apparatus.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating the breakdown voltage measuring device of the present invention;

FIG. 2 is a cross section illustrating an embodiment of the image forming apparatus;

FIG. 3 is a cross section of another embodiment of the image forming apparatus including a plurality of developing devices;

FIG. 4 is a schematic diagram illustrating the main portion of the developing device of the image forming apparatus of the present invention;

FIG. 5 is a schematic diagram illustrating the layer structures of the a-Si photoconductor for use in the image forming apparatus of the present invention;

FIG. 6 is a schematic diagram illustrating the image forming apparatus comprising the process cartridge of the present invention; and

FIG. 7 is a diagram illustrating the surf fixing device which fixes a fixing film by rotation.

### DETAILED DESCRIPTION OF THE INVENTION

Generally, the present invention provides a carrier for use in developing latent electrostatic images (hereinafter simply referred to as carrier) which contains at least a magnetized particulate core material and a resin layer covering the surface thereof. The present invention is described below in detail with reference to a number of illustrative embodiments and accompanying drawings.

The carrier of the present invention has a particulate core material having a weight average particle diameter (Dw) of from 25 to 45 μm and preferably from 30 to 45 μm.

When the weight average particle diameter (Dw) is too large, carrier adhesion tends to be deterred. However, when the toner density is high in this case, background fouling rapidly increases and the filament of magnetic brushes is hardened and thus the mobility thereof deteriorates. A carrier having too small weight average particle diameter may scatter and adhere to the latent image bearing member.

The carrier of the present invention has a magnetic moment of from 65 to 90 Am²/Kg for 1 kOe. Within this range, carrier adhesion rarely occurs. A photoconductor drum or a fixing roller may be damaged by carriers adhered thereto.

The carrier adhesion is a phenomenon in which a carrier adheres to the image portion or the background portion of a latent electrostatic image. The carrier adheres to these portions more easily when the electric field is strong. Since the electric field at the image portion is weakened by development with a toner, the image portion usually does not attract the scattered carrier relative to the background portion.

Thus, this carrier adhesion can be prevented by a carrier having the magnetic moment of from 65 to 90 Am²/Kg. However, abnormal images such as the mottled uneven density image mentioned above may be formed as a side effect.

The inventors of the present invention have identified a relationship between the mottled uneven density image and the breakdown voltage of a carrier occurring when a DC voltage is applied thereto and measured with a measuring device comprising a rotation sleeve including at least a stationary magnet therein and an electrode with a void of 1 mm therebetween. Further, when the measured breakdown voltage is not less than 1,000 V, the mottled uneven density image is improved.

As the breakdown voltage becomes low, the leak at the time of development becomes large and, therefore, a latent electrostatic image tends to deteriorate.

In addition, it has also been found that when the breakdown voltage is not less than 1,000 V, the margin of the carrier adhesion mentioned above is improved. As the breakdown voltage becomes low, the amount of charges guided to the core material in the carrier becomes large and therefore the carrier adhesion easily occurs.

Further, when a photoconductor and a magnet sleeve have a high linear velocity, the carrier adhesion tends to occur.

The breakdown voltage means a voltage at which the resistance sharply drops (i.e., when an excessive current runs abruptly). Namely it is the voltage at which the current restrained to be slight by the carrier outbursts caused by the pressure of the increasing voltage.

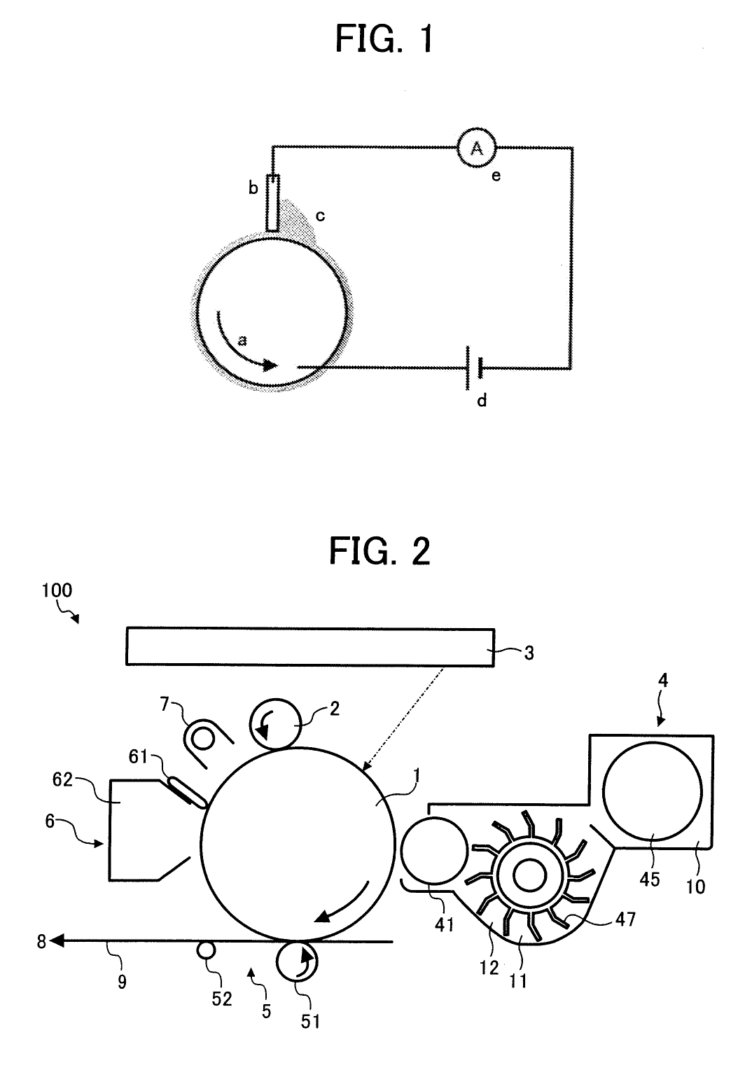

The method of measuring the breakdown voltage of the present invention is as follows as illustrated in FIG. 1:
(1) load 20 g of a target carrier (c) on a sleeve (a) comprising a stationary magnet therein which is rotating at 250 rpm;
(2) apply a voltage <E> to the sleeve (a) and a doctor electrode (b) disposed with a void of 1 mm therebetween;
(3) read a current <I> 2 minutes after the voltage <E> is applied and calculate a resistance <R> at the time of application of the voltage <E> by using the following relationship: [R=E/I (Ω)]; and
(4) repeat this measurement until the voltage at which the resistance sharply drops is obtained while increasing this application voltage.

This voltage obtained is the breakdown voltage mentioned above.

As mentioned above, the breakdown voltage means a voltage at which the resistance sharply drops (i.e., when an excessive current runs abruptly). Namely it is the voltage at which the current restrained to be slight by the carrier outbursts due to the pressure of the increasing voltage.

For the carrier comprised in the developer of the present invention, occurrence of carrier adhesion can be preferably prevented when the particulate core material includes particulates having a diameter smaller than 22 μm in an amount not greater than 3% by weight and preferably not greater than 1% by weight.

In the case of a carrier having a small particle diameter, carrier adhesion is mostly caused by particulates having a small particle diameter smaller than 22 μm. The inventors of the present invention have performed a carrier adhesion evaluation test on small-sized carriers having a weight average particle diameter (Dw) of from 25 to 45 μm while changing the ratio by weight of the carrier particles having a particle diameter smaller than 22 μm. It appears that no serious problem occurs when the ratio of the carrier particles having a particle diameter smaller than 22 μm is not greater than 3% by weight and the carrier adhesion protection is further improved when the ratio of the carrier particles having a particle diameter smaller than 22 μm is not greater than 1% by weight.

The particulate core material of the carrier of the present invention has a magnetic moment of from 65 to 90 Am²/Kg upon application of a magnetic field of 1 kOe.

The magnetic moment can be measured as follows:
(1) fill 1.0 g of the particulate carrier core material in a cell having a cylinder form and set the cell in a measuring device B-H tracer (BHU-60 manufactured by RikenDenshi Co., Ltd.);
(2) gradually increase the magnetic field until it is 3 kOe and then gradually decrease the magnetic field to zero;
(3) then gradually increase the magnetic field having the opposite direction to the first magnetic field until it is 3 kOe and then gradually decrease the magnetic field to zero;
(4) repeat (2) and (3) until a B-H curve chart is obtained; and
(5) calculate the magnetic moment for 1 kOe based on the B-H curve chart.

As mentioned above, the particulate core material for use in the present invention is a magnetic particulate having a magnetic moment of from 65 to 90 Am²/Kg upon application of a magnetic field of 1 kOe and the carrier has a breakdown voltage not less than 1,000 V measured upon application of a DC voltage with a measuring device comprising a rotation sleeve including at least a stationary magnet therein and an electrode with a void of 1 mm therebetween.

Any known magnetic materials can be used as the particulate core material constituting the carrier of the present invention. Specific preferred material examples of the particulate core materials having the characteristics mentioned above include high resistance/high-magnetized ferrites and specific examples thereof include ferrites containing Mn referred to as Mn containing ferrites such as Mn ferrites, Mn—Mg ferrites and Mn—Mg—Sr ferrites. These materials contain preferably 38 to 60% by mole of MnO and more preferably 45 to 55% by mole.

In addition, when preparing the particulate core material, it is effective to additionally have a surface oxidizing treatment process using an electric furnace, rotary kiln, etc. after main baking to raise the breakdown voltage of the carrier. Namely, it is possible to adjust the breakdown voltage and magnetization in preparing the particulate core material.

The surface oxidizing treatment process is a baking process in an atmosphere or an atmosphere having a less content of nitrogen. When the nitrogen content is low, the breakdown voltage tends to rise.

The treatment temperature depends on the breakdown voltage and the magnetization. To prevent form deterioration of the particulate core material, the treatment temperature is preferably lower than that for the main baking and especially preferably not higher than 1200° C. When the treatment temperature is high, the breakdown voltage tends to be high.

In addition, the bulk density of the particulate core material is preferably not less than 2.2 g/cm³ for carrier adhesion protection, and more preferably not less than 2.3 g/cm³. When the bulk density of the particulate core material is low, generally the material tends to be porous or have a bumpy surface.

When a particulate core material has a low bulk density and a large magnetic moment (Am²/Kg) for 1 kOe, the substantial magnetic moment per particle is small, which works to disadvantages for carrier adhesion prevention.

In addition, when a particulate core material has a bumpy surface, the thickness of the coated resin varies depending on the portion of the particulate core material. Thus the charge amount and resistance of such a particulate core material tend to be non-uniform. This affects durability with time, carrier adhesion, etc.

In addition, to adjust the surface properties and form of such a particulate core material, it is preferred to contain at least one of Si, Ca, Cu, V, K, Cl and Al therein as a single element or compounds thereof. The content of the elements is preferably not greater than 5% by mole per the total content of magnetic particle components and more preferably not greater than 1% by mole. When at least two of the elements mentioned above or compounds thereof are included therein, the total content is preferably not greater than 1 mol % by mole.

The specific resistance of a carrier can be adjusted by controlling the resistance and thickness of the coated resin on the particulate core material.

It is also possible to add particulate electroconductive additives to the resin layer to adjust the specific resistance of the carrier. Specific examples of such electroconductive additives include particulates of metal or metal oxide such as electroconductive ZnO and Al, SnO₂ prepared by various kinds of methods or where various kinds of elements are doped, boric compounds such as TiB₂, ZnB₂ and MoB₂, SiC, electroconductive polymers such as polyacetylene, polypara-phenylene, (para-phenylene sulphide) polypyrrole and polyethylene, carbon blacks such as furnace black, acetylene black and channel black.

These particulate electroconductive additives can be uniformly dispersed in the coated resin layer by placing a particulate electroconductive additive in a solvent or resin solution for use in coating followed by uniformly dispersing the solvent or solution with a dispersing machine having a medium such as ball mill or bead mill or stirring the solvent or solution with a stirrer having wings rotating at a high speed.

The carrier of the present invention is prepared by forming a resin layer on the surface of the particulate core material mentioned above. Various kinds of known resins for use in preparing carriers can be used as resins to form such a resin layer.

Silicone resins having the repeat unit illustrated below can be preferably used for the present invention. 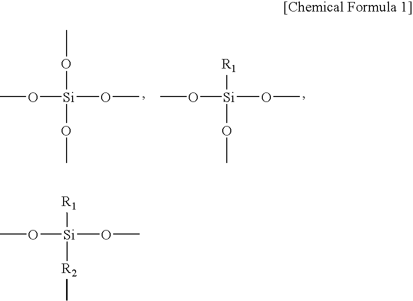
(wherein R¹ represent a hydrogen atom, a halogen atom, a hydroxyl group, a methoxy group, a lower alkyl group having a 1 to 4 carbon atoms or an aryl group (such as a phenyl group and a tolyl group), and R² represents an alkylene group having a 1 to 4 carbon atoms, or an arylene group (such as a phenylene group)

Straight silicone resins can be used to form a resin layer of the carrier of the present invention. Specific examples of such straight silicone resins include KR271, KR272, KR282, KR 252, KR255, KR 152 (manufactured by Shin-Etsu Chemical Co., Ltd.), SR2400 and SR2406 (manufactured by Dow Corning Toray Silicone Co., Ltd.).

In addition, modified silicone resins can be used to form a resin layer of the carrier of the present invention. Specific examples of such modified silicone resins include an epoxy modified silicone resin, an acryl modified silicone resin, a phenol modified silicone resin, a urethane modified silicone resin, apolyester modified silicone resin and an alkyd modified silicone resin.

Specific examples of the modified silicone resins include ES-1001N (an epoxy modified silicone resin), KR-5208 (an acryl modified silicone resin), KR-5203 (a polyester modified silicone resin), KR-206 (an alkyd modified silicone resin), KR-305 (a urethane modified silicone resin) (all of which mentioned so far manufactured by Shin-Etsu Chemical Co., Ltd.), SR2115 (an epoxy modified silicone resin) and SR2110 (an alkyd modified silicone resin) (manufactured by Dow Corning Toray Silicone Co., Ltd. for the last two).

The silicone resins mentioned above which can be used in the present invention can contain amino-silane coupling agents and the content thereof is from 0.001 to 30% by weight. Specific examples of such amino-silane coupling agents are shown in Table 1.

TABLE 1

| | | |
|---|---|---|
| H₂N(CH₂)₃Si(OCH₃)₃ | MW | 179.3 |
| H₂N(CH₂)₃Si(OC₂H₅)₃ | MW | 221.4 |
| H₂NCH₂CH₂CH₂Si(CH₃)₂(OC₂H₅) | MW | 161.3 |
| H₂NCH₂CH₂CH₂Si(CH₃)(OC₂H₅)₂ | MW | 191.3 |
| H₂NCH₂CH₂NHCH₂Si(OCH₃)₃ | MW | 194.3 |
| H₂NCH₂CH₂NHCH₂CH₂CH₂Si(CH₃)(OCH₃)₂ | MW | 206.4 |
| H₂NCH₂CH₂NHCH₂CH₂CH₂Si(OCH₃)₃ | MW | 224.4 |
| (CH₃)₂NCH₂CH₂CH₂Si(CH₃)(OC₂H₅)₂ | MW | 219.4 |
| (C₄H₉)₂NC₃H₆Si(OCH₃)₃ | MW | 291.6 |

Further, it is also possible to use the following resins alone or in combination with the silicone resins mentioned above as resins to form the resin layer mentioned above of the present invention.

The resin to be combined with the resins mentioned above is most preferably an acrylic resin. A cross-linked resin between an acrylic resin and an amino resin can be also used. Specific examples of such amino resins include a guanamine resin and a melamine resin.

Other specific examples include styrene-containing resins such as a polystyrene, a chloropolystyrene, a poly-α-methyl styrene, a styrene chlorostyrene copolymer, a styrene-propylene copolymer, a styrene-butadiene copolymer, a styrene-vinylchloride copolymer, a styrene-vinylacetate copolymer, a styrene-maleic acid copolymer, a styrene-acrylic acid copolymer (a styrene-methyl acrylate, a styrene-ethyl acrylate copolymer, a styrene-butyl acrylate copolymer, a styrene-octyl acrylate copolymer, a styrene-phenyl acrylate copolymer, etc.), a styrene-methacrylic acid ester copolymer (a styrene-methyl methacrylate copolymer, a styrene-ethyl methacrylate copolymer, a styrene-butyl methacrylate copolymer, a styrene-phenyl methacrylate copolymer, etc.), a styrene-α-methyl acrylate chloride copolymer, a styrene-acrylic nitrile-acrylic acid ester copolymer, an epoxy resin, a polyester resin, a polyethylene resin, a polypropylene resin, an ionomer resin, a polyurethane resin, a ketone resin, an ethylene-ethyl acrylate copolymer, a xylene resin, a polyamide resin, a phenol resin and a polycarbonate resin.

Specific methods of forming a resin layer on the surface of a particulate core material of a carrier include a spray drying method, a dip-coating method and a powder coating method but are not limited thereto. Any known methods can be used.

Particularly a method using a fluid bed type coating device is effective to form a uniform film.

The thickness of the resin layer formed on the surface of the particulate core material of a carrier is normally 0.02 to 1 μm and preferably from 0.03 to 0.8 μm. The thickness of the resin layer is so thin that the particle size distributions of the resin layer coated carrier and the particulate core material are almost substantially the same.

Resin dispersed carriers in which magnetic particulates are dispersed in known resins such as a phenolic resin, an acrylic resin and a polyester resin can be used as the carrier of the present invention.

The developer of the present invention comprises the carrier mentioned above and a toner.

The toner for use in the present invention is a binder resin comprising a thermoplastic resin as a main component which contains a colorant, a particulate, a charge controlling agent, a release agent, etc. Various kinds of known toners can be used.

This toner can be prepared by various kinds of toner preparation methods such as a polymerization method and a granulation method and have an irregular form or sphere form. In addition, magnetic toners and non-magnetic toners can be used.

Specific examples of the binder resins contained in a toner include the following and can be used alone or in combination: styrene and monopolymers of its substitution such as polystyrene and polyvinyltoluene; styrene copolymers such as a styrene-p-chlorostyrene copolymer, a styrene-propylene copolymer, a styrene-vinyltoluene copolymer, a styrene-methyl acrylate copolymer, a styrene-ethyl acrylate copolymer, a styrene-butyl acrylate copolymer, a styrene-methyl methacrylate copolymer, a styrene-ethyl methacrylate copolymer, a styrene-butyl methacrylate copolymer, a styrene-methyl α-chloromethacrylate copolymer, a styrene-acrylonitrile copolymer, a styrene-vinyl methyl ether copolymer, a styrene-vinyl methyl ketone copolymer, a styrene-butadiene copolymer, a styrene-isoprene copolymer, a styrene-maleic acid copolymer, and a styrene-maleic acid ester copolymer; acrylic binder resins such as a polymethylmethacrylate, a polybutylmethacrylate; and others such as a polyvinylchloride polymer, a polyvinylacetate polymer, a polyethylene polymer, a polypropylene polymer, a polyester polymer, a polyurethane polymer, an epoxy polymer, a polyvinyl butyral, a polyacrylic resin, a rosin, a rosin modified resin, a terpene resin, a phenolic resin, an aliphatic or alicyclic hydrocarbon resin; an aromatic petroleum resin, a chlorinated paraffin and a paraffin wax.

In addition, a polyester resin can lower a fusion viscosity and secure its stability while the toner is stored relative to a styrene-containing resin or an acryl-containing resin. This polyester resin can be obtained through polycondensation reaction, for example, between an alcoholic component and a carboxylic component.

Specific examples of the alcoholic components include diols such as polyethylene glycols, diethylene glycols, triethylene glycols, 1,2-proplyene glycol, 1,3-propylene glycol, neopenthylene glycols and 1,4-butene diol, 1,4-bis(hydroxymethyl) cyclohexane, etherified bisphenols such as bisphenol A, hydrogen added bisphenol A, polyoxyethylenified bisphenol A and polyoxypropylenized bisphenol A, secondary alcohol monomers which are substituted by saturated or unsaturated hydrocarbons having 3 to 22 carbon atoms, and alcohol monomers having three or more hydroxy groups such as sorbitols, 1,2,3,6-hexane tetrol, 1,4-sorbitan, pentaethritols, dipentaethritols, tripentaethritols, saccharose, 1,2,4-butanetriol, 1,2,5-pentanetriol, glycerols, 2-methylpropanetriol, 2-methyl-1,2,4-butanetriol, trimethylolethane, trimethylolpropane, and 1,3,5-trihydroxymetylbenzene.

Specific examples of carboxylic acid components to obtain a polyester resin include monocarboxylic acid such as palmitic acid, stearic acid, oleic acid, maleic acid, fumaric acid, mesaconic acid, citraconic acid, terephthalic acid, cyclohexanedicarboxylic acid, succinic acid, adipic acid, sebacic acid, malonic acid, secondary organic acid monomer thereof substituted by saturated or unsaturated hydrocarbon group having 3 to 22 carbon atoms, anhydrides of these acids, lower alkyl esters, dimers from linoleic acid, 1,2,4-benzenetricarboxylic acid, 1,2, 5-benzenetricarboxylic acid, 2,5,7-naphthalenetricarboxylic acid, 1,2,4-butanetricarboxylic acid, 1,2,hexanetricarboxylic acid, 1,3-dicarboxyl-2-methyl-2-methylenecarboxypropane, tetra(methylenecarboxyl)methane, 1,2,7,8-octanetetracarboxylic acid, pyrithioxine hydrochloride trimer, and polycarboxylic acid monomers containing three or more hydroxyl groups such as anhydrides of these acids.

Specific examples of epoxy resins include polycondensation compounds between a bisphenol A and an epochlorhydrin available in the market such as EPOMIK R362, R364, 365, R366, R367 and R369 (all of which are manufactured by Mitsui Chemicals, Inc.), EPOTOHTO YD-011, YD-012, YD-014, YD-904 and YD-017 (manufactured by Tohto Kasei), EPICOAT 1002, 1004 and 1007 (all of which are manufactured by Shell Chemical Company).

Any known dyes and pigments can be used as the colorants of the present invention alone or in combination

Specific examples of the colorants include carbon black, lamp black, iron black, cobalt blue, nigrosin dyes, aniline blue, phthalocyanine blue, Hansa Yellow G, Rhodamine 6G Lake, chalco oil blue, chrome yellow, quinacridone, benzidine yellow, rose Bengal, triarilmethane containing dyes, monoazo dyes and pigments, and disazo dyes and pigments.

In addition, magnetic toners containing magnetic substances therein can be also used.

Specific examples of such magnetic particulate substances include strong magnetic substances such as iron and cobalt, magnetites, hematites, Li containing ferrites, Mn—Zn containing ferrites, Cu—Zn containing ferrites, Ni—Zn containing ferrites and Ba ferrites.

To sufficiently control charging properties of the toners, charge controlling agents such as metal complex salts of monoazo dyes, nitrohumic acid and its salts, salicylic acid, naphthoic acid, dicarboxyl acid, metal complexes thereof including Co, Cr, or Fe, amino compounds, quaternary ammonia compounds, organic dyes can be included.

Further, release agents can be optionally added to the toner of the present invention. Specific examples of such release agents include low molecular weight polypropylenes, low molecular weight polyethylenes, carnauba wax, microcrystalline wax, jojoba wax, rice wax, montanic acid wax and are not limited thereto. These can be used alone or in combination.

In addition, additives can be added to the toners of the present invention if necessary.

To obtain quality images, it is important for the toner to have good fluidity. It is effective to externally add particulate hydrophobized metal oxides, particulate lubricants and metal oxides, particulate organic resins and metal soaps can be used as additives.

Specific examples of such additives include lubricants such as polytetrafluoroethylene containing fluorine reins and zinc stearate, abrasives such as cerium oxides and silicon carbides, fluidizers such as inorganic oxides such as SiO₂ and TiO₂ the surface of which is hydrophbized, compounds known as caking inhibitors, and their surface treated compounds. Among them, hydrophobic silica is particularly preferred to improve the fluidity of a toner.

The toner of the present invention preferably has a weight average particle diameter (Dt) of from 3.0 to 10.0 μm, more preferably from 3.0 to 9.0 μm, and most preferably from 4.0 to 7.5 μm.

The ratio of the toner to the carrier is preferably 2 to 25 parts by weight of the toner per 100 parts by weight of the carrier and particularly preferably 4 to 15 parts by weight.

In the developer comprising the carrier of the present invention and a toner, the covering ratio of the toner to the carrier is preferably 10 to 80% and more preferably 20 to 60%.

The covering ratio mentioned above is calculated by the following relationship.
[Mathematical Expression 1]
Covering rate (%)=(Wt/Wc)×(pc/pt)×(Dc/Dt)×(1/4)×100 (wherein Dc and Dt represent a weight average particle diameter (μm) of the carrier and the toner, respectively, Wt and Wc represent the weights (g) of the toner and the carrier, respectively, and pt and pc represent the true densities of the toner and the carrier, respectively.)

The weight average particle diameter of the carrier, the particulate core material and the toner of the present invention are calculated, for example, in the case of the particulate core material, using the particle size distribution measured based on the number of particles (i.e., the frequency of the number of particles and particle diameter).

The weight average particle diameter (Dw) is represented by the following relationship:
[Mathematical Expression 2]
   Dw=[1/Σ(nD3)]×[Σ(nD4)]
      (wherein D represents a representative particle diameter (μm) in each channel and n represents the total number of particles in each channel.)

The channel means a length to equally divide the particle size range in the particle size distribution chart and 2 μm in the present invention.

The representative particle diameter in each channel is the lower limit particle diameter in each channel.

The particle size analyzer used to measure the particle size distribution is a microtrack particle size analyzer (model HRA9320-X100: manufactured by Honeywell International Inc.).

The measuring conditions are as follows:
(1) particle size range: 100 to 8 μm;
(2) channel length (channel width): 2 μm;
(3) number of channels: 46; and
(4) refraction index: 2.42

The image bearing member is fixed in the image forming apparatus. The gap between the image bearing member and a developer holding member such as a developing sleeve in the development area is measured by a feeler gauge. The gap is adjusted to be in a predetermined range before the development device is fixed. As the developing device using the carrier or the developer of the present invention, the gap is preferably maintained inthe range of from 0.30 to 0.80 mm inthe developing area in terms of development stability. The image bearing member is fixed in the image forming apparatus.

When the gap is too short, an image once developed on the image bearing member may be scraped off by the carrier magnetic brush. To the contrary, too a wide gap is not preferred since the amount of toner used for development on the edges of a solid image tends to be large relative to that on the center thereof, namely, the edge effect easily occurs.

To achieve a gradation in an image by developed area ratio to the unit area, the developing device preferably has a voltage application mechanism by which a DC bias is applied to the developer holding member and more preferably a voltage application mechanism by which a bias voltage where an AC voltage is overlapped with a DC voltage is applied to the developer holding member.

The developer container of the present invention is a container containing the developer of the present invention. As the container, various kinds of known containers can be used. Further, a process cartridge detachably attached to an image forming apparatus which comprises a developing device and at least one of an image bearing member, a charging member and a cleaner can be used.

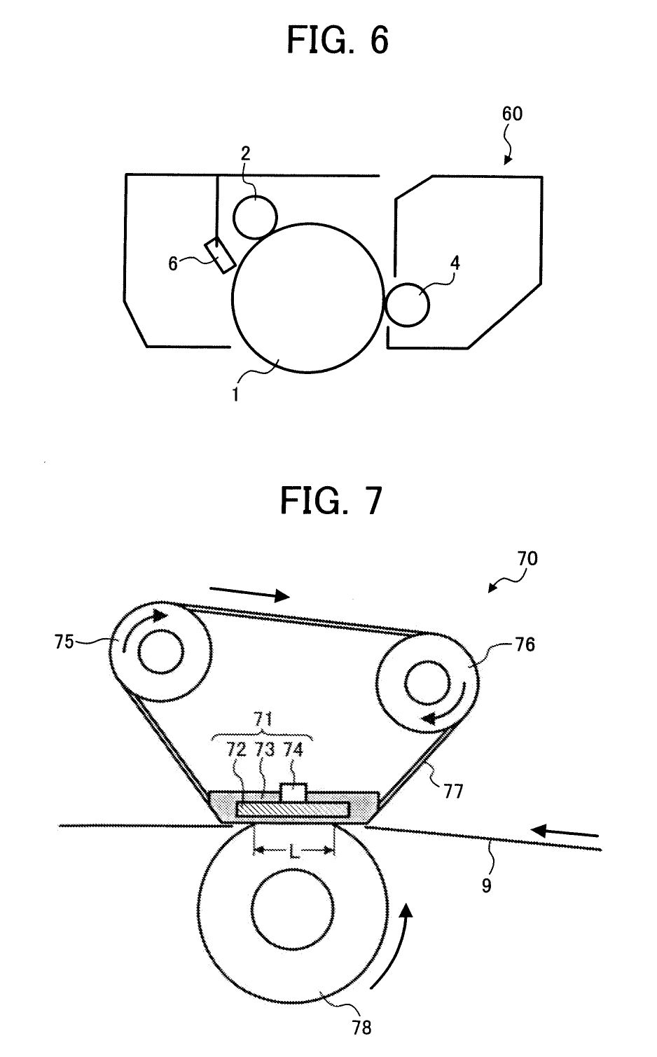

FIG. 6 is a schematic diagram illustrating an image forming apparatus comprising the process cartridge containing the developer.

In FIG. 6, numerals 60, 1, 2, 4 and 6 represent the entire process cartridge, an image bearing member such as a photoconductor, a charging member such as a charger, a developing device and a cleaner, respectively.

The process cartridge 60 of the present invention comprising the developing device 4, and at least one of the photoconductor 1, the charging member 2 and the cleaner 6 is detachably attached to an image forming apparatus 100 and 200 such as a photocopier or a printer.

The image forming apparatus 100 and 200 of the present invention is an image forming apparatus comprising the developer container of the present invention as a developer container. Various kinds of known image forming apparatus can be used as the image forming apparatus in this case.

The developing method of the present invention uses the developer of the present invention as a developer when analogue images or digital images are developed using a bias voltage having only a DC bias or a bias voltage having a DC voltage overlapped with an AC bias voltage.

The image forming apparatus of the present invention including the developing device is now described with reference to the accompanying drawings.

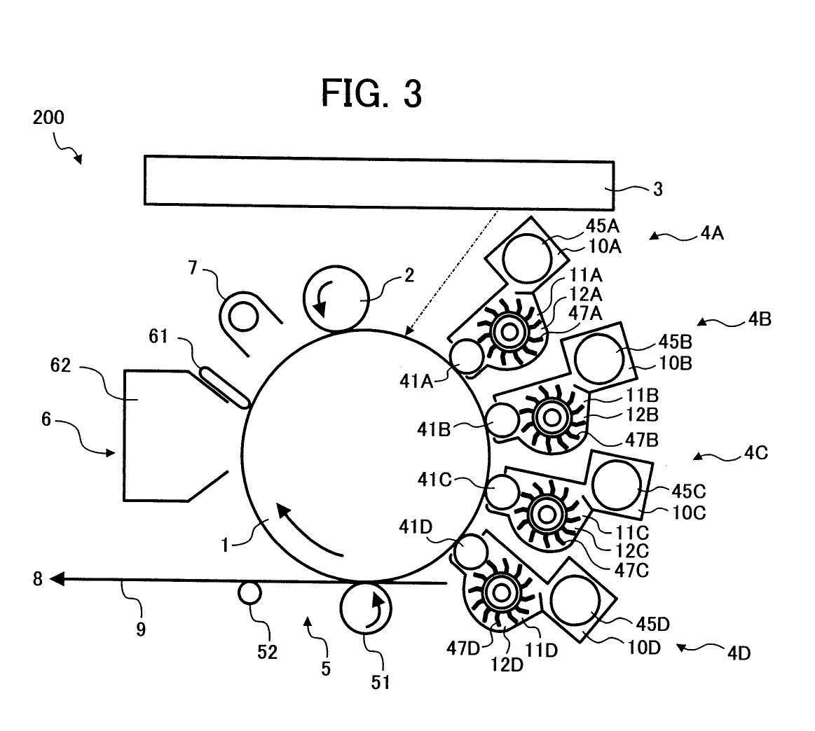

FIGS. 2 and 3 are cross sections illustrating an embodiment of a portion of the apparatus of the present invention.

Around an image forming apparatus 1 such as a photoconductor having a drum form, a charging member 2 such as a charger, an image irradiation system 3, a developing device 4, a transfer mechanism, a cleaner 6 and a quenching lamp 7 are arranged. Images are formed by the following operations.

A negative and positive image forming process is now described.

The image bearing member 1 typified by a photoconductor (OPC) having an organic photoconductive layer is discharged by the quenching lamp 7 and negatively and uniformly charged by the charging member 2 such as a charger and charging rollers. Then, the image irradiation system 3 irradiates the image bearing member 1 with a laser beam emitted therefrom to form a latent image thereon (irradiated part potential is lower than that of a non-irradiated part in absolute values).

The laser beam emitted from a semiconductor laser diode is reflected at a polyangular polygon mirror rotating at a high speed and scans the surface of the image bearing member 1 in the direction of the rotational axis thereof.

The thus formed latent image is developed with the developer fed onto the developing sleeve 41 to form a visual toner image on the image bearing member 1. The developer comprises a mixture of the toner particles and the carrier particles.

When the latent image is developed, a voltage application device (not shown) applies to the developing sleeve 41 an appropriate DC developing bias between the potentials of the irradiated portion and non-irradiated portion of the image bearing member or a developing bias in which an AC voltage is overlapped with the DC voltage.

A transfer medium 9 such as paper is fed from a paper feeding system (not shown) to a gap between the image bearing member 1 and the transferring device 51 while the transfer medium 9 is synchronized to the timing of the front edge of the toner image by a pair of register rollers comprising top and bottom rollers. Thus the toner image is transferred. The reverse polarity to the polarity of the toner charge is preferably applied to the transferring device 51.

Then, the transfer medium 9 is separated from the image bearing member 1, discharged by a discharging mechanism 52 and output as an output image via a fixing device 8.

The toner particles remaining on the image bearing member 1 are collected by a cleaning member 61 to a toner collection 62 room in the cleaner.

The collected toner particles can be optionally transferred to the image developing portion and/or a toner replenishment portion by a toner recycling device (not shown) for reuse.

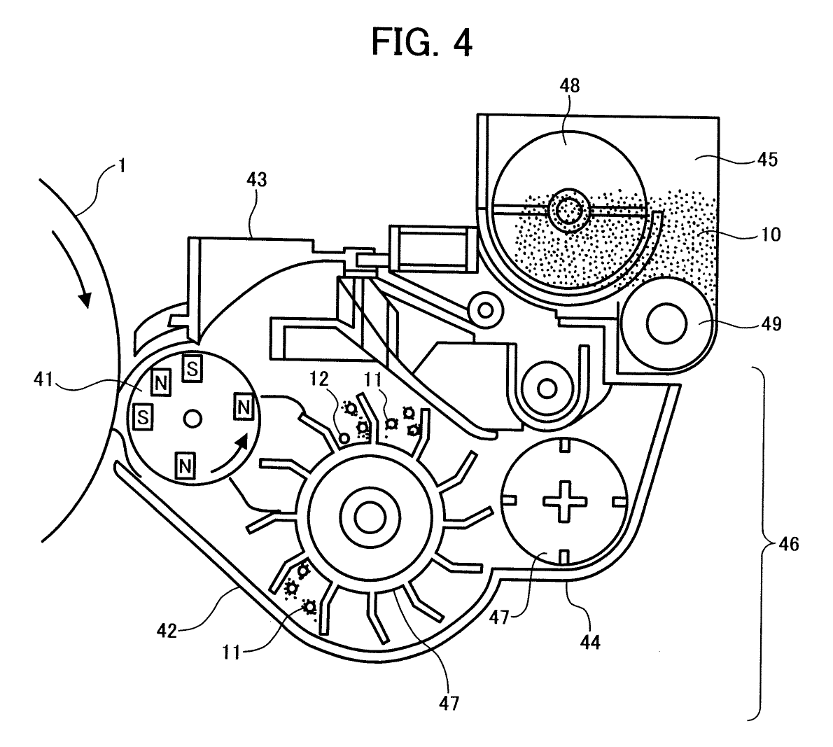

FIG. 4 is a schematic diagram illustrating the main portion of the image developing device in the image forming apparatus.

The developing device disposed opposite to the photoconductor drum 1 functioning as a latent image bearing member comprises the developing sleeve 41, a developer container 42, a doctor blade 43 functioning as a regulating member and a supporting case 44.

The supporting case 44 having an opening on the side of the photoconductor 1 is combined with a toner hopper 45 functioning as a toner container accommodating a toner 10.

The toner hopper 45 is adjacent to a developer container 46 accommodating a developer 11 comprising the toner 10 and carrier particles which comprises a developer stirring mechanism 47 for imparting friction charge and/or detachment charge to toner particles.

A toner agitator 48 and a toner replenishment mechanism 49 functioning as a toner replenishment device are disposed in the toner hopper 45, and are driven by a driving device (not shown). The toner agitator 48 and the toner replenishment mechanism 49 send out the toner 10 in the toner hopper 45 to the developer container 46 while stirring the toner 10.

In a space between the photoconductor 1 and the toner hopper 45 is disposed the developing sleeve 41.

The developing sleeve 41 is driven in the direction indicated by an arrow by a driving device (not shown) and contains at least a magnet (not shown) functioning as a magnetic field generation device to form a magnet brush with carrier particles. The magnet is disposed in a manner so as to have a relatively fixed position to the developing device 4.

To the opposite side of the supporting case 44 attached to the developer containing member 42, the doctor blade 43 is fitted in a body thereto. The regulating device, i.e., the doctor blade 43, is located so as to keep a constant gap between the front end thereof and the peripheral surface of the developing sleeve 41.

The toner 10 fed from the inside of the toner hopper 45 by the toner agitator 48 and the toner replenishment mechanism 49 is transported to the developer container 46 and stirred by the developer stirring mechanism 47, which imparts a desired friction and/or detachment charge to the toner 10. Then, the toner 10 forming the developer 11 with the carrier particles is borne by the developing sleeve 41 and transported to a position facing the peripheral surface of the photoconductor drum 1. Then only the toner 10 is electrostatically attached to the latent image formed on the photoconductor drum 1 to form a toner image thereon.

The image forming apparatus of the present invention can optionally have a plurality of the developing devices around the image bearing member. In this case, respective latent images formed on the image bearing member by the developing devices are developed and then transferred to form an overlapped developed image on the transfer medium.

<Amorphous Silicon Photoconductor>

The photoconductors for use in the present invention are prepared by heating a conductive substrate to 50 to 400° C. and forming a photoconductive layer comprising a-Si thereon by a filming method such as a vacuum depositing method, a sputtering method, an ion plating method, a heat CVD method, a light CVD method and a plasma CVD method. Thus the a-Si photoconductors are made.

Among them, it is preferred to use the plasma CVD method in which an a-Si accumulating film is formed on a substrate by decomposing a material gas through DC, or high frequency or microwave glow discharge.

An a-Si photoconductor is suitably preferred for image forming apparatus such as high speed photocopiers and laser beam printers (LBPs) because such a photoconductor has a good surface hardness and is highly sensitive to light having a long wavelength such as a semiconductor laser (770 to 900 nm) and strong for repetitive use.

<Layer Structure>

Specific examples of the layer structures of a-Si photoconductors are as follows:

FIGS. 4A to 4D are schematic diagrams illustrating layer structures.

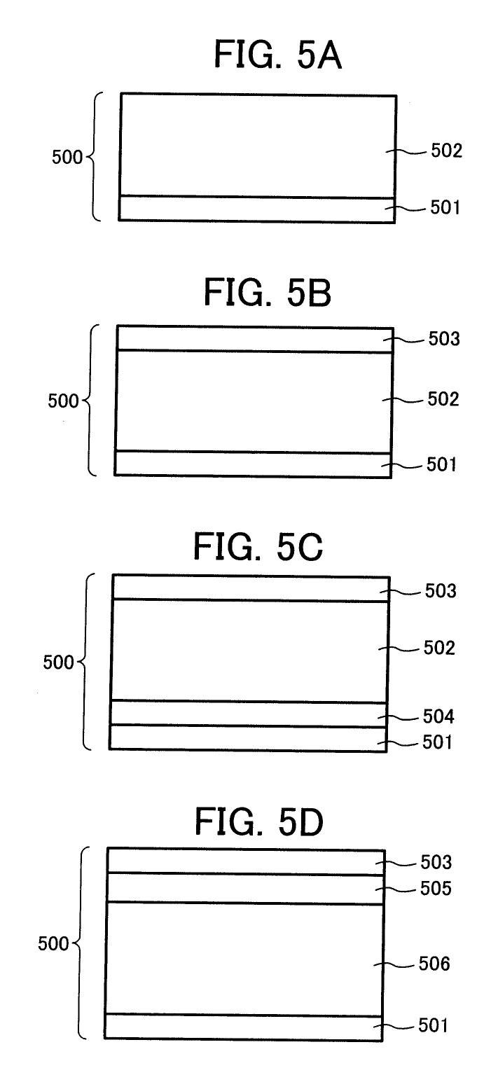

FIG. 5A illustrates a photoconductor 500 comprising a substrate 501 and a photoconductivge layer 502 thereon comprising a-Si.

FIG. 5B illustrates a photoconductor 500 comprising a substrate 501, a photoconductive layer 502 thereon comprising a-Si, and an a-Si containing surface layer 503.

FIG. 5C illustrates a photoconductor 500 comprising a substrate 501, a photoconductive layer 502 thereon comprising a-Si, an a-Si containing surface layer 503 and an a-Si containing charge injection prevention layer 504.

FIG. 5D illustrates a photoconductor 500 comprising a substrate 501, a photoconductive layer 502 thereon and an a-Si containing surface layer 503. The photoconductive layer 502 comprises a charge generation layer 505 containing a-Si and a charge transport layer 506.

<Substrate>

Electroconductive or insulative substrates can be used for the photoconductor for use in the present invention.

Specific electroconductive substrate include metals such as Al, Cr, Mo, Au, In, Nb, Te, V, Ti, Pt, Pd and Fe and their alloys such as stainless thereof.

In addition, insulative substrates such as films or sheets of synthetic resins of, for example, polyester, polyethylene, polycarbonate, cellulose acetate, polypropylene, polyvinylchloride, polystyrene and polyamide, glasses and ceramics can be used, provided at least the surface thereof on which the photosensitive layer is formed is treated to be electroconductive.

The substrate can have a cylinder form, a plate form or an endless belt form with a smooth or a concave-convex surface. The thickness of a substrate can be determined to form a desired photoconductor of an image forming apparatus. When the photoconductor is required to be flexible, the substrate can be as thin as possible unless the substrate loses its function. However, the thickness is typically not less than 10 μm in terms of production, handling conveniences and a mechanical strength of the electrophotographic photoconductor.

<Charge Injection Prevention Layer>

As illustrated in FIG. 5C, the a-Si photoconductors of the present invention preferably comprises a charge injection prevention layer between the substrate and the photoconductive layer to prevent charge injection from the side of the conductive substrate if necessary.

That is, the charge injection prevention layer has a function of preventing charge injection from the substrate to the photoconductive layer when the photoconductive layer is treated to have a certain polarity on its free surface. To the contrary, when the photoconductive layer is treated to have the opposite polarity on its free surface, the charge injection preventionlayerdoesnotpreventthecharge injection. Namely, the function of the charge injection prevention layer is polarity-dependent. To impart this function to the charge injection prevention layer, more atoms controlling conductivity should be included therein than those in the photoconductive layer.

The charge injection prevention layer preferably has a thickness of from 0.1 to 5 μm, more preferably from 0.3 to 4 μm, and most preferably from 0.5 to 3 μm in terms of desired electrophotographic properties, economic effects, etc.

<Photoconductive Layer>

The photoconductive layer 502 is formed on an undercoat layer optionally formed on the substrate. The thickness of the photoconductive layer 502 which is determined in terms of desired electrophotographic properties and economic effects is preferably from 1 to 100 μm, more preferably from 20 to 50 μm, and most preferably from 23 to 45 μm.

<Charge Transport Layer>

The charge transport layer is a layer having a function of transporting charges when the photoconductive layer is functionally separated.

The charge transport layer comprises a-SiC (H, F, O) which at least includes silicon atoms, carbon atoms and fluorine atoms, and optionally includes hydrogen atoms and oxygen atoms. The charge transport layer has predetermined photoconductive properties, especially a charge retainability, a charge generation capability and a charge transportability. In the present invention, the charge transport layer preferably includes at least oxygen atoms.

The thickness of the charge transport layer which is determined in terms of predetermined electrophotographic properties and economic effects is preferably from 5 to 50 μm, more preferably from 10 to 40 μm, and most preferably from 20 to 30 μm.

<Charge Generation Layer>

The charge generation layer is a layer which has a function of generating charges when the photosensitive layer is functionally separated.

The charge generation layer comprises a-Si:H which at least includes silicon atoms and may further include hydrogen atoms while having substantially no carbon atoms and has predetermined photoconductive properties, especially a charge generation capability and a charge transportability.

The thickness of the charge transport layer which is determined in terms of predetermined electrophotographic properties and economic effects is preferably from 0.5 to 15 μm, more preferably from 1 to 10 μm, and most preferably from 1 to 5 μm.

<Surface Layer>

The a-Si photoconductor for use in the present invention can optionally comprise a surface layer on the photoconductive layer formed on the substrate as mentioned above. The surface layer is preferably an a-Si containing surface layer.

The surface layer has a free surface and is formed to achieve the objects of the present invention for providing humidity resistance, repeated use resistance, electric pressure resistance, environment resistance, durability of the photoconductor, etc.

The surface layer preferably has a thickness of from 0.01 to 3 μm, more preferably from 0.05 to 2 μm, and most preferably from 0.1 to 1 μm. When the thickness is too thin, the surface layer is scraped and lost due to abrasion, etc., while the photoconductor is used. When the thickness is too thick, the electrophotographic properties deteriorate, e.g., the residual potential of the photoconductors increases.

The fixing device here is a surf fixing device which fixes an image by rotating a film as illustrated in FIG. 7.

The film is a heat resistant film having an endless belt form and is suspended and strained over a driving roller functioning as a supporting rotation body of the film, a driven roller and a heating member such as a heater which is fixedly supported by a heater supporter (not shown) located between and below the driving roller and the driven roller.

The driven roller also serves as a tension roller of the film, and the film rotates clockwise indicated by an arrow illustrated in FIG. 7 due to the clockwise rotation of the driving roller. The rotation speed of the film is controlled to have the same speed as that of a transfer material at a fixing nip area L where a pressing member such as a pressure roller and the film contact each other.

The pressing member has a rubber elastic layer having good releasability such as silicone rubbers, and rotates counterclockwise while in contact at the fixing nip area L normally with a total pressure of from 4 to 10 kg.

The film preferably has a total thickness not greater than 100 μm, and preferably not greater than 40 μm to have a good heat resistance, releasability and durability. Specific examples of such films include films formed of a single-layered or a multi-layered film of heat resistant resins such as polyimide, polyetherimide, polyethersulphide (PES) and a tetrafluoroethyleneperfluoroalkyl vinylether copolymer resin (PFA), for example, at least on the image contacting side of a film having a thickness of 20 μm is coated a film at least having a 10 μm releasing coating layer comprising a fluorine resin such as polytetrafluoroethylene resin (PTFE) and PFA with a conductive additive or an elastic layer comprising fluorine rubber or silicone rubber.

FIG. 7 is a diagram illustrating an embodiment of the heating member of the present invention which comprises a flat substrate and a heat generator such as a fixing heater. The flat substrate is formed of a material having a high thermal conductivity and a high resistivity such as aluminum. The heat generator comprising a resistance heater is disposed on the surface where the heat generator is in contact with the film in the longitudinal direction.

The heat generator comprises an electric resistant material such as Ag/Pd and Ta₂N linearly or zonally coated by a screen printing method, etc. Electrodes (not shown) are formed at each end of the heat generator and the resistant heater generates a heat when electricity passes though the electrodes.

Further, a fixing temperature sensor comprising a thermistor is located on the side of the substrate opposite to the side on which the heat generator is located.

Temperature information of the substrate detected by the fixing temperature sensor is transmitted to a controller (not shown), which controls an electric energy provided to the heat generator to control the heating member at a predetermined temperature.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present invention is now described using examples and comparative examples.

Manufacturing Examples of Toner

(Manufacturing Example 1 of toner)

| | | |
|---|---|---|
| Polyester resin | 100 | parts |
| (polycondensation compound of ethylene oxide added | | |
| alcohol of bisphenol A and propylene oxide added alcohol | | |
| and terephthalic acid and trimellitic acid: molecular weight | | |
| is about 12,000: glass transition temperature is about | | |
| 60° C.) | | |
| Quinacridone containing magenta pigment | 3.5 | parts |
| Quaternary ammonium salt including fluorine | 4 | parts |

The components mentioned above were sufficiently mixed and then fused and kneaded by a two-axis extruder. Subsequent to cooling, the resultant was coarsely pulverized by a cutter mill, finely pulverized by a jet air fine pulverizer and classified by an air separator. The thus obtained mother toner particles had a weight average particle diameter of 6.2 μm and a true specific gravity of 1.20 g/cm³.

Further, a 1.0 part of particulate anhydride silica (R972 manufactured by Japan Aerosil Co.) was added per 100 parts of this mother toner particle and mixed with a Henschel mixer. The toner I was thus obtained.

Evaluation of Core Material Characteristics

The particle size distribution, the magnetic moment for 1 kOe and the breakdown voltage of the carrier core materials comprising ferrite for use in Examples were measured. The results are shown in FIG. 2.

TABLE 2

| | | | Particle size distribution | | | | |
|---|---|---|---|---|---|---|---|
| | | | Content | Content | Content | | |
| | | | ratio of | ratio of | ratio of | | |
| | | | particles | particles | particles | | |
| | | Weight | having | having | having | | |
| | | average | diameter | diameter | diameter | | |
| | | particle | smaller | smaller | larger | Magnetic | Breakdown |
| | Fe₂O₃ | diameter | than 22 μm | than 44 μm | than 62 μm | moment | voltage |
| | (mol %) | (μm) | (wt %) | (wt %) | (wt %) | (Am²/kg) | (V) |
| Core | 48 | 34.9 | 4.1 | 79.8 | 1.8 | 72 | 1800 |
| material | | | | | | | |
| (1) | | | | | | | |
| Core | 48 | 35.5 | 1.6 | 84.1 | 1.7 | 73 | 1800 |
| material | | | | | | | |
| (2) | | | | | | | |
| Core | 48 | 35.3 | 0.7 | 82.9 | 1.7 | 72 | 1900 |
| material | | | | | | | |
| (3) | | | | | | | |
| Core | 49 | 35.8 | 0.8 | 86 | 1.5 | 75 | 2100 |
| material | | | | | | | |
| (4) | | | | | | | |
| Core | 48 | 35.1 | 0.7 | 81.7 | 1.6 | 74 | 1100 |
| material | | | | | | | |
| (5) | | | | | | | |
| Core | 83 | 34.9 | 0.7 | 80.4 | 1.4 | 81 | 500 |
| material | | | | | | | |
| (6) | | | | | | | |
| Core | 39 | 35.4 | 0.8 | 83.9 | 1.6 | 62 | 1700 |
| material | | | | | | | |
| (7) | | | | | | | |

Manufacturing Examples of Carrier
(Manufacturing Example 1 of Carrier)

Two weight % of a solid silicone resin (SR2411: manufactured by Dow Corning Toray Silicone Co., Ltd.) against a carrier core material was measured and was diluted with an organic solvent to obtain a resin solution. Eleven weight % of an amino silane coupling agent H₂N(CH₂)₃Si (OC₂H₅)₃ against the solid resin were added in the resin solution.

The thus obtained silicone resin solution was coated on the surface of the core material (1) (MnO: 52 mol %, surface oxidization treatment process: strong) in Table 2 using a fluid bed type coating device in a 100° C. atmosphere at a rate of about 40 g/min. Subsequent to heating at 250° C. for a two hour baking, the resultant was pulverized by a sieve having a mesh of 63 μm and Carrier A was thus obtained.

(Manufacturing Example 2 of Carrier)

Carrier B was obtained in the same manner as in Manufacturing Example 1 except that the core material (2) (MnO: 52 mol %, surface oxidization treatment process: strong) in Table (2) was used.

(Manufacturing Example 3 of Carrier)

Carrier C was obtained in the same manner as in Manufacturing Example 1 except that the core material (3) (MnO: 52 mole %, surface oxidization treatment process: strong) in Table (2) was used.

(Manufacturing Example 4 of Carrier)

Carrier D was obtained in the same manner as in Manufacturing Example 1 except that the core material (4) (MnO: 49 mol % and MgO: 2 mol %, surface oxidization treatment process: strong) in Table (2) was used.

(Manufacturing Example 5 of Carrier)

Carrier E was obtained in the same manner as in Manufacturing Example 1 except that the core material (5) (MnO: 52 mol %, surface oxidization treatment process: weak) in Table (2) was used.

(Manufacturing Example 6 of Carrier)

Carrier F was obtained in the same manner as in Manufacturing Example 1 except that the core material (4) (MnO: 49 mol % and MgO: 2 mol %, surface oxidization treatment process: strong) in Table (2) was used, the coating resin was changed to an acrylic resin and the baking after coating was for an hour at 175° C.

(Manufacturing Example 7 of Carrier)

Carrier G was obtained in the same manner as in Manufacturing Example 6 except that the coating resin was changed to an acrylic resin containing a guanamine resin. (Manufacturing Example 8 of Carrier)

Carrier H was obtained in the same manner as in Manufacturing Example 6 except that the coating resin was changed to a mixture of the acrylic resin containing a guanamine resin and the silicone resin with a mixture ratio of 1 to 1 by weight.

(Manufacturing Example 9 of Carrier)

Carrier I was obtained in the same manner as in Manufacturing Example 1 except that the core material (6) (MnO: 17 mol %, surface oxidization treatment process: none) in Table (2) was used.

(Manufacturing Example 10 of Carrier)

Carrier J was obtained in the same manner as in Manufacturing Example 1 except that the core material (7) (MnO: 61 mol %, surface oxidization treatment process: strong) in Table (2) was used.

### Example 1

Toner I (7 parts) was added to Carrier A (93 parts) and stirred with a ball mill for 10 minutes and Developer A having a toner density of 7% was obtained. The thus obtained Developer A was evaluated with regard to mottled images due to non-uniform density and carrier adhesion. The results are shown in Table 3.

### Example 2

Carrier B was used instead of Carrier A in Example 1 and evaluated with regard to mottled images due to non-uniform density and carrier adhesion in the same manner. The results are shown in Table 3.

### Example 3

Carrier C was used instead of Carrier A in Example 1 and evaluated with regard to mottled images due to non-uniform density and carrier adhesion in the same manner. The results are shown in Table 3.

### Example 4

Carrier D was used instead of Carrier A in Example 1 and evaluated with regard to mottled images due to non-uniform density and carrier adhesion in the same manner. The results are shown in Table 3.

### Example 5

Carrier E was used instead of Carrier A in Example 1 and evaluated with regard to mottled images due to non-uniform density and carrier adhesion in the same manner. The results are shown in Table 3.

### Example 6

Carrier F was used instead of Carrier A in Example 1 and evaluated with regard to mottled images due to non-uniform density and carrier adhesion in the same manner. The results are shown in Table 3.

### Example 7

Carrier G was used instead of Carrier A in Example 1 and evaluated with regard to mottled images due to non-uniform density and carrier adhesion in the same manner. The results are shown in Table 3.

### Example 8

Carrier H was used instead of Carrier A in Example 1 and evaluated with regard to mottled images due to non-uniform density and carrier adhesion in the same manner. The results are shown in Table 3.

### Comparative Example 1

Carrier I was used instead of Carrier A in Example 1 and evaluated with regard to mottled images due to non-uniform density and carrier adhesion in the same manner. The results are shown in Table 3.

### Comparative Example 2

Carrier J was used instead of Carrier A in Example 1 and evaluated with regard to mottled images due to non-uniform density and carrier adhesion in the same manner. The results are shown in Table 3.

(Evaluation)

(1) Evaluation of Mottled Images Due to Non-uniform Density

A common image forming apparatus in which a double-component developing device was set was used to write latent electrostatic images on the OPC in an analogue system to output halftone images under the following development conditions.
Distance PG between the OPC and the developing sleeve: 0.35 mm
Development nip width: 3 mm
Linear velocity of the OPC: 245 mm/s
Linear velocity of the developing sleeve: 515 mm/s
Application voltage between the developing sleeve and the OPC: an AC having a wavelength of 9 kHz and Vpp of 900 V overlapped with a DC. The DC voltage and the surface potential of the OPC were adjusted such that the image density of a half tone image formed was 0.8.

The thus obtained half tone images were evaluated on the degree of occurrence of mottled images due to non-uniform density under and ranked according to the following criteria. The results are shown in Table 3.
E: Excellent
G: Good
NP: No practical problem
NG: No good

(2) Carrier Adhesion Evaluation

A common image forming apparatus in which a double-component developing device was set was used to develop images with a background potential (development bias—charging potential in the range of from 100 to 200 V) and carrier adhesion on the photoconductor was ranked under the following criteria. The results are shown in Table 3.

TABLE 3

| | Mottled | |
|---|---|---|
| | images due to | |
| | non-uniform | Carrier |
| | density | adhesion |
| Example 1 | G | NP |
| Example 2 | G | G |
| Example 3 | G | E |
| Example 4 | E | E |
| Example 5 | NP | G |
| Example 6 | E | E |
| Example 7 | E | E |
| Example 8 | E | E |
| Comparative | NG | NP |
| Example 1 | | |
| Comparative | G | NG |
| Example 1 | | |

E: Excellent
G: Good
NP: No practical problem
NG: No good

As seen in Table 3, the problems of mottled images due to non-uniform density and carrier adhesion are improved by the present invention.

According to present invention, the carrier and a developer comprising the carrier is provided which can produce good halftone images without denting the advantages of the carrier being a small-sized particle and without causing the carrier adhesion problem with a wide margin.

| | | |
|---|---|---|
| Example 1 | | |
| Comparative | G | NG |
| Example 1 | | |

As seen in Table 3, the problems of mottled images due to non-uniform density and carrier adhesion are improved by the present invention.

According to present invention, the carrier and a developer comprising the carrier is provided which can produce good halftone images without denting the advantages of the carrier being a small-sized particle and without causing the carrier adhesion problem with a wide margin.

In addition, the life of an image forming apparatus using the carrier is long since carrier adhesion is restrained and thus contacting members in the image forming apparatus is not damaged.

Further, it is possible to provide an image forming apparatus in which the developer is set, a developer container containing the developer, a developing method using the developer and a process cartridge containing the developer.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A developer for use in developing latent electrostatic images, comprising:
a toner, and
a carrier, the carrier comprising:
a particulate core material, the particulate core material having a weight average particle diameter (Dw) of from 25 to 45 μm and a magnetic moment of from 65 to 90 μm²/Kg at 1 KOe; and
a resin layer located on a surface of the particulate core material,
wherein the carrier has a breakdown voltage not less than 1,000 V.

2. The developer according to claim 1, wherein the toner has a weight average particle diameter (Dt) of from 3 to 10 μm.

3. An image forming apparatus, comprising:
an image bearing member configured to bear at least one latent electrostatic image thereon;
at least one developing device comprising a developer holding member, the developing device being configured to develop the latent electrostatic image with at least one developer to form at least one toner image on the image bearing member;
a transfer device configured to transfer the at least one toner image onto a transfer medium; and
a fixing device configured to fix the at least one toner image on the transfer medium,
wherein the developer comprises:
a toner; and
a carrier, the carrier comprising:
a particulate core material, the particulate core material having a weight average particle diameter (Dw) of from 25 to 45 μm and a magnetic moment of from 65 to 90 μm²/Kg at 1 KOe; and
a resin layer located on a surface of the particulate core material,
wherein the carrier has a breakdown voltage not less than 1,000 V.

4. The image forming apparatus according to claim 3, including a plurality of developing devices, wherein the image bearing member is configured to bear a plurality of respective latent electrostatic images, and the plurality of developing devices are configured to develop the plurality of respective latent electrostatic images, with the respective developers including different color toners to form a plurality of color toner images on the image bearing member, wherein the transfer device is configured to transfer the plurality of toner images onto the transfer medium to form a multi-color toner image and the fixing device is configured to fix the multi-color image on the transfer medium.

5. The image forming apparatus according to claim 3, wherein a gap between the image bearing member and the developer holding member is between 0.30 to 0.80 mm.

6. The image forming apparatus according to claim 3, wherein the developing device further comprises a voltage applying mechanism configured to apply a DC bias voltage to the developer holding member.

7. The image forming apparatus according to claim 3, wherein the developing device further comprises a voltage applying mechanism, the voltage applying mechanism applying to the developer holding member a bias voltage in which an AC voltage overlaps with a DC voltage.

8. The image forming apparatus according to claim 3, wherein the image bearing member comprises an amorphous silicon photoconductor.

9. The image forming apparatus according to claim 3, wherein the fixing device comprises:
a heating member, the heating member comprising a heat generator;
a film configured to be rotated while the film is in contact with the heating member; and
a pressing member configured to press the film against the heating member,
wherein the heating member and the film are configured to apply heat to at least one toner image while the pressure member presses the transfer medium against the film to fix at least one toner image on the transfer medium upon application of the heat while the transfer medium passes between the film and the pressing member.

10. The image forming apparatus according to claim 3, wherein the image forming apparatus comprises a developer container, the developer container housing a developer including
a toner, and
a carrier, the carrier comprising:
a particulate core material, the particulate core material having a weight average particle diameter (Dw) of from 25 to 45 μm and a magnetic moment of from 65 to 90 Am²/Kg at 1 KOe; and
a resin layer located on a surface of the particulate core material,
wherein the carrier has a breakdown voltage not less than 1,000 V.

11. A developing method comprising:
forming a latent electrostatic image on an image bearing member; and
developing the latent image with a developer to form a toner image on the image bearing member, wherein the developer comprises:
a toner; and
a carrier, the carrier comprising:
a particulate core material, the particulate core material having a weight average particle diameter (Dw) of from 25 to 45 μm and a magnetic moment of from 65 to 90 Am²/Kg at 1 KOe; and
a resin layer located on a surface of the particulate core material,
wherein the carrier has a breakdown voltage not less than 1,000 V.

12. A process cartridge detachably attachable to an image forming apparatus, comprising:
a developing device configured to develop a latent electrostatic image with a developer to form a toner image; and
at least one image bearing member configured to bear the latent electrostatic image thereon, a charger configured to charge the image bearing member and a cleaner configured to clean a surface of the image bearing member,
wherein the developer comprises:
a toner; and
a carrier, the carrier comprising:
a particulate core material, the particulate core material having a weight average particle diameter (Dw) of from 25 to 45 μm and a magnetic moment of from 65 to 90 Am²/Kg at 1 KOe; and
a resin layer located on a surface of the particulate core material,
wherein the carrier has a breakdown voltage not less than 1,000 V.
